(19) United States
(12) Patent Application Publication
(10) Pub. No.: US 2008/0078153 A1
(43) Pub. Date: Apr. 3, 2008

(54) Foreign Body Detector For An Agricultural Harvester

(76) Inventor: Rainer Schafer, Zweibrucken (DE)

Correspondence Address: DEERE & COMPANY, ONE JOHN DEERE PLACE, MOLINE, IL, 61265, US

(21) Appl. No.: 11/835,477

(22) Filed: Aug. 8, 2007

(30) Foreign Application Priority Data
Sep. 8, 2006 (DE) 10 2006 042 373.9

(51) Int. Cl. A01D 75/18

(52) U.S. Cl. 56/10.2 J

(57) ABSTRACT

A foreign body detector for an agricultural harvester is provided having a sensing element which is fitted such that it is movable transversely to a direction of conveyance of the crop and which, during the harvesting operation, bears against the received crop. The foreign body detector has a position sensor set up to register the position of the sensing element, and an evaluation circuit, which can be operated to calculate, on the basis of the signals of the position sensor, information relating to the velocity and/or acceleration of the sensing element and, for the purpose of generating a signal value indicating the take-up of a foreign body, to make a comparison with a threshold value.

### FIELD OF THE INVENTION

The invention relates to a foreign body detector for an agricultural harvester, comprising a sensing element which is fitted such that it is movable transversely to a direction of conveyance of the crop and which, during the harvesting operation, bears against the received crop.

### BACKGROUND OF THE INVENTION

Within the prior art, various detectors have been described for foreign bodies in agricultural machines, which foreign bodies have been taken up with the crop. Common amongst these are metal detectors which impart a magnetic field to a gathering duct of the harvester. Induction coils register changes in the magnetic field which are caused by a ferromagnetic foreign body taken up with the crop, and are connected to a detection circuit, which, where necessary, brings about a stoppage of the gathering elements of the harvester. With these metal defectors, foreign bodies consisting of non-ferromagnetic materials cannot be detected.

In addition, mechanical solutions have been proposed in which the shape of the gathering elements is variable and is recognized (DD 117 030 A and DD 120 782 A). The technical complexity and the non-reliability of the mechanical components may however be regarded as a drawback, for which reason such solutions have yet to be encountered in practical use.

Moreover, vibration sensors have been described, which are based on sound signals and register vibrations generated in the event of a foreign body impacting with a feed roller in the gathering duct (U.S. Pat. No. 5,092,818, U.S. Pat. No. 7,022,012). In sensors of this type, foreign bodies embedded in the crop mat cannot be detected, or can only be detected with reduced sensitivity.

Finally, it has been proposed to equip a pre-compacting roller, which moves up and down depending on the thickness of the crop mat, with an acceleration sensor (EP 0 217 417 A, EP 0 217 418 A, DE 199 04 626 A, EP 1 632 128 A and U.S. Pat. No. 6,637,179). If a certain acceleration value of the pre-compacting roller is exceeded, it is assumed that a foreign body, for example a stone, is contained in the crop mat, and a stoppage of the gathering elements of the harvester is automatically brought about. The acceleration of the pre-compacting roller transversely to the direction of conveyance can also be measured by registering the pressure in a hydraulic cylinder connected thereto, as is described in DE 296 18 473 U.

EP 0 217 417 A, EP 0 217 418 A and DE 199 04 626 C do not describe the acceleration sensor in detail. The acceleration sensors according to EP 1 632 128 A and U.S. Pat. No. 6,637,179 respectively comprise a mass which is movably connected to the pre-compacting roller and a switch or a potentiometer which measures the position of the mass relative to the pre-compacting roller. It may be regarded as a drawback with these detectors that a number of separate components is necessary for the acceleration sensor. Moreover, the functioning of the acceleration sensor after a lengthy period of operation can be impaired by dirt contamination, especially if the acceleration sensor is not installed in a sealed housing or the sealing is defective.

For the mapping of the yield and for the automatic dosing of silage additives, it has been proposed to use potentiometers to register the position of pre-compacting rollers which are movable transversely to the direction of conveyance (DE 195 24 752 A, DE 199 03 471 C).

### SUMMARY OF THE INVENTION

The object on which the invention is founded is seen as providing a defector, of the type stated in the introduction, for foreign bodies taken up with the crop, which detector allows a foreign body taken-up to be readily defected.

A foreign body detector according to the invention comprises a position sensor, which registers the position of a sensing element which is movable transversely to the direction of conveyance of the crop. During the harvesting operation, the sensing element bears against the received crop and moves transversely to the direction of conveyance of the crop, in dependence on the thickness of the received crop mat. The position sensor is connected to an evaluation circuit, which uses the signals of the position sensor to calculate information concerning the velocity and/or acceleration of the sensing element, especially by the formation of the first and/or second temporal derivation of the signal of the position sensor. This information is compared by the evaluation circuit with a threshold value in order to transmit an appropriate signal value should the calculated information on the velocity and acceleration of the sensing element indicate that a foreign body is contained in the crop.

In this way, a detection of foreign bodies which may have been taken up with the crop mat is realized with simple means.

The sensing element is preferably pre-tensioned in the direction of the crop, so that it exerts upon it a compression effect. As the sensing element, in particular a conveying roller (e.g. pre-compacting roller in the gathering duct of a forage harvester, or a vertically movably disposed, lower inclined conveyor roller in the inclined conveyor of a combine harvester), may enter into consideration, which can be actively driven or freely rotated with the crop and is preferably disposed in the gathering conveyor of the harvester. Inter alia, separate probes or sensors, which interact with the crop mat and which do not serve for the active conveyance of the crop, may also however be used.

The signal value of the evaluation circuit is expediently used to automatically stop a gathering conveyor of the harvester if the velocity or acceleration of the sensing element, calculated by the evaluation circuit, indicates that a foreign body is contained in the crop. It should here be borne in mind that the sensing element moves, with increasing thickness of the crop mat, in a first direction, and with decreasing thickness of the crop mat, in an opposite, second direction. The facility thus exists to take info account only motions of the sensing element which travel in the first direction and which indicate that a foreign body is approaching the sensing element and, following determination of the velocity and acceleration of the sensing element, to make a comparison with the threshold value and to ignore the motions running in the second direction. These latter motions, which might indicate, inter alia, that the foreign body is re-distancing itself from the sensing element, may also however (alternatively or additionally) be taken into account. To this end, the value amounts or squares of the velocity and/or acceleration values can be compared with corresponding threshold values.

The intensity of the variations in crop mat thickness can depend, inter alia, on the homogeneity of the crop stock or on the quality of a received swath. In order to prevent unwanted false triggering actions conditioned by variations in the crop density, the evaluation circuit, in a preferred embodiment of the invention, can evaluate the position measurements over a certain time span, in each case immediately preceding the measurement in question, in order to determine the extent of the typical changes in position of the sensing element (and of the velocities or accelerations) and to use them for the automatic determination of the threshold value. As the threshold value, a multiple (e.g. double) of the mean velocity or acceleration values indicating an increase in the thickness of the crop mat may be used.

As the position sensor for the sensing element, a potentiometer in a linearly displaceable or rotatable embodiment may be used. However, any other chosen position sensors may also be used, for example induction distance sensors, distance meters based on ultrasound or light waves, or a plurality of light barriers.

The output signals of the position sensor can also be used for yield measurement and/or for the automatic dosing of a silage additive.

### BRIEF DESCRIPTION OF THE DRAWINGS

An illustrative embodiment of the invention is described on the basis of the appended drawing figures wherein:

FIG. 1 is a side view of a self-propelled harvester in the form of a forage harvester having a crop receiver;

FIG. 2 is a side view of the gathering housing of the harvester; and

FIG. 3 is a flow chart according to which the evaluation circuit operates.

### DESCRIPTION OF THE PREFERRED EMBODIMENT

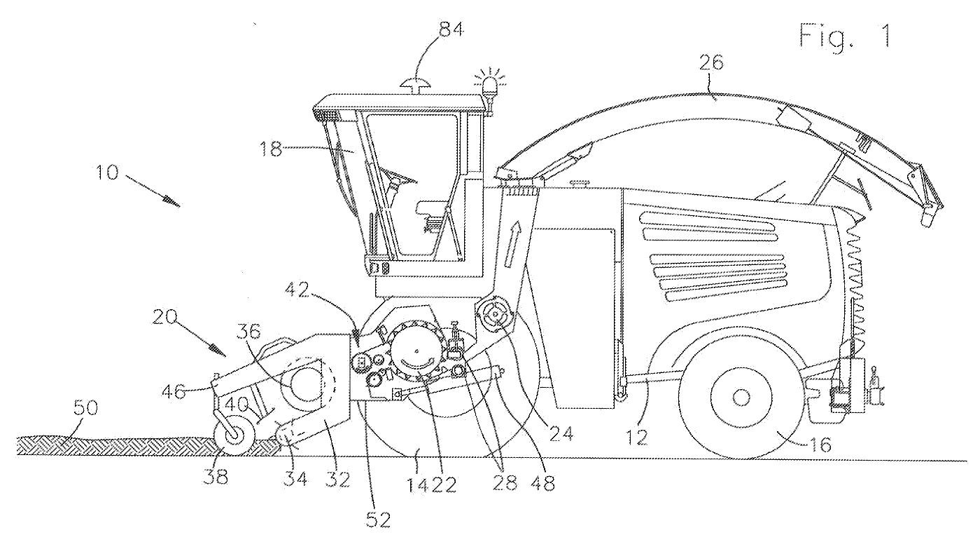

In FIG. 1, a harvester 10 is represented in the style of a self-propelled forage harvester. The harvester 10 is built on a frame 12 which is supported by front driven wheels 14 and steerable rear wheels 16. The harvester 10 is operated from a driver's cab 18, from which a front-mounted harvesting attachment in the form of a crop receiver 20 can be looked into. Crop, for example grass or the like, which has been collected from the ground by means of the crop receiver 20 is fed, via a gathering conveyor 42 having pre-compacting rollers disposed within a gathering housing 52 on the front side of the forage harvester 10, to a chopping cylinder 22, which chops it into small pieces and delivers it to a conveying apparatus 24. The crop leaves the harvester 10 for a trailer travelling alongside, via a discharge shaft 26 which is rotatable about an approximately vertical axis and is adjustable in inclination. Extending between the chopping cylinder 22 and the conveying apparatus 24 is an after-crushing apparatus 28 having two grain processor rollers by which the crop to be conveyed is fed tangentially to the conveying apparatus 24.

The crop receiver 20 is configured as a so-called pick-up. The crop receiver 20 is built on a stand 32 and is supported on the soil via supporting wheels 38 which are fitted on both sides and are each fastened to the stand 32 via a support 46. The object of the crop receiver 20 consists in collecting the crop deposited on the ground of a field in a swath 50 and in feeding it to the harvester 10 for further processing. To this end, the crop receiver 20, during the harvesting operation, is moved over the field at a short distance from the soil, whilst for transport on a road or on paths, it is raised by means of a hydraulic cylinder 48, which pivots the gathering housing 52 and the thereto attached crop receiver 20 about the rotational axis of the chopping cylinder 22. The hydraulic cylinder 48 serves also to adjust the height of the crop receiver 20 above the ground and to adjust the bearing pressure of the supporting wheels 38 on the soil. The crop receiver 20 includes a delivery conveyor 38 in the form of an auger, which conveys the received crop from the sides of the crop receiver 20 to a centrally located delivery opening (not shown), behind which there follows the gathering conveyor 42. The crop receiver 20 also, like the delivery conveyor 36, has a relatively driven pick-up rotor 34, which is disposed beneath the delivery conveyor 36 and with its conveying tines raises the crop from the soil so as to transfer it to the delivery conveyor 36. In addition, a hold-down device 40 in the form of a metal plate disposed over the pick-up rotor 34 is fastened to the stand 32.

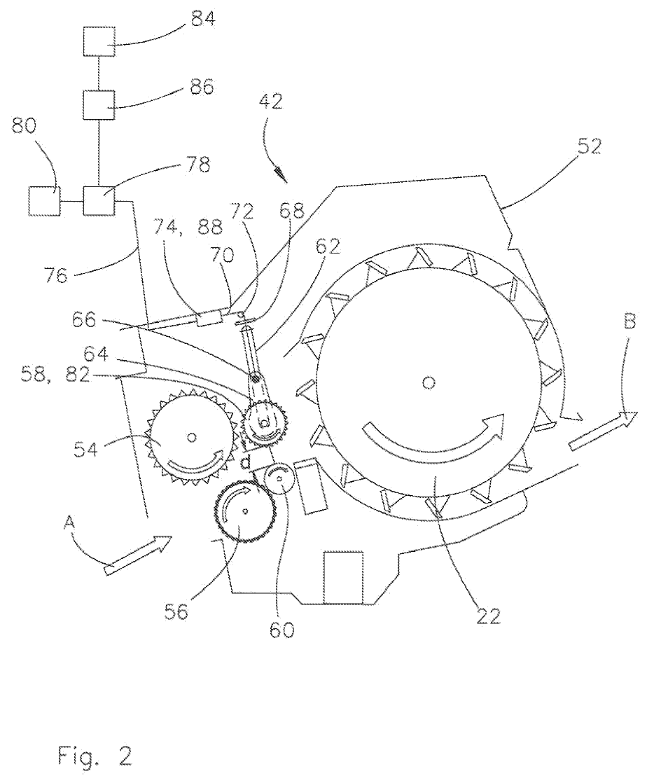

In the description that follows, direction specifications, such as laterally, bottom and top, relate to the direction of forward motion V of the crop receiver 20, which direction, in FIGS. 1 and 2, runs to the left.

FIG. 2 shows details of the gathering conveyor 42 and of the chopping cylinder 22, which are disposed in the gathering housing 52. The gathering conveyor 42 contains two front pre-compacting rollers 54, 56, which bring about a pre-compaction of the crop entering at A. A homogeneous compaction and onward guidance of the crop is then effected between the two rear pre-compacting rollers 58, 60, which have a variable distance apart d.

The rear lower pre-compacting roller 60 is fixed-mounted, whilst the shaft of the rear upper pre-compacting roller 58 is guided in lateral slots 62. At the two ends of the rear upper pre-compacting roller 20 there is respectively disposed a non-co-rotating flange 64. The two flanges 64 support a transverse strut 66, which lies parallel to the pre-compacting roller 58 and moves back and forth with the pre-compacting roller 58 and the ends of which are likewise guided in the lateral slots 62. The rear upper pre-compacting roller 58 can move essentially in the vertical direction between a lower stop and an upper stop 68. The upper pre-compacting rollers 54, 58 are pre-tensioned downwards, in a manner which is known per se, by the force of a spring and/or of a hydraulic cylinder (see DE 10 2005 059 953 A and the prior art which is cited there), whilst the lower pre-compacting rollers 56, 60 are mounted rigidly on the gathering housing 52.

With respect to its longitudinal extent, in the central region of the transverse strut 66 there is fitted a cable 70, which is guided via a deflection pulley 72 to a potentiometer 74. Without further transfer losses, the vertical deflection of the transverse strut 66 and hence also of the rear upper pre-compacting roller 58 is thereby registered and converted into a measurement value which is dependent on the gap width or the distance d between the two rear pre-compacting rollers 58, 60. The change in resistance generated by the potentiometer 74 is converted into a voltage signal and is relayed via a line 76 to an evaluation circuit 78. For reaction speed reasons, as far as possible no bus, but rather a direct connection, is used for the line 76. Where necessary, a sufficiently fast bus can also, however, be used. The evaluation circuit 78 is connected to an apparatus 80 for stopping the gathering conveyor 42. This apparatus 80 can comprise in a manner which is known per se (see DE 199 55 901 A and DE 102 07 467 A and the prior art which is cited there, the content of which is included, by reference, in the present documents), a disengageable clutch in the drive train of the pre-compacting rollers 54-60 and a locking pawl, which, for the stoppage of the gathering conveyor 42, can be brought into engagement with a gearwheel in drive connection with the pre-compacting rollers 54-60. It would also be conceivable to drive the pre-compacting rollers 54-60 hydraulically or electrically and for the stoppage to automatically stop, or even reverse the drive by suitable valves or switching elements.

Other than as represented in the drawing, instead of the rear pre-compacting roller 58, the front upper pre-compacting roller 54, which is likewise downwardly pre-tensioned by spring force, can be connected to the potentiometer 74. It would also be conceivable to attach both upper pre-compacting rollers 54, 58 jointly to a rocker and to register their position with the potentiometer 74.

In the arrangement represented in FIG. 2, the rear upper pre-compacting roller 58 serves as a sensing element 82 which is fitted such that it is movable transversely to the direction of conveyance of the crop and which, during the harvesting operation, bears against the received crop. The potentiometer 74 serves as a position sensor 88 for registering the position of the sensing element 82 (i.e. of the pre-compacting roller 58).

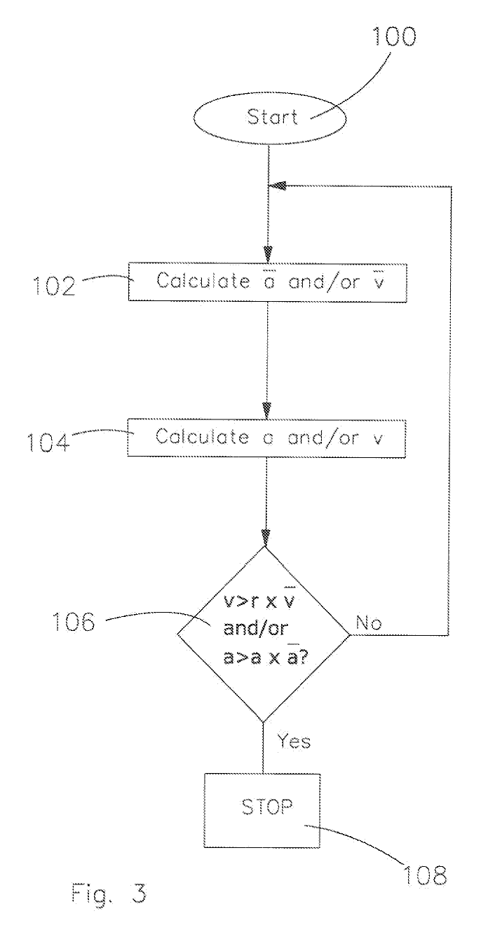

FIG. 3 shows a flow chart according to which the evaluation circuit 78 proceeds during the operation. Following the start in step 100, in step 102 the mean vertical velocity ā of the sensing element 82 over a predetermined period of, for example, 10 s duration is calculated on the basis of previously received signals of the position sensor 88 (potentiometer 74). If the harvester 10 has not yet been continuously in operation over a period of such length, a predetermined value, or a value which can be inputted by the operator via a suitable input device (e.g. keyboard or rotary knob), may also be used. In one possible embodiment, only positive velocity values corresponding to an upward motion of the sensing element 82 are taken into account in calculating the mean velocity. In other embodiments, the absolute values or squares of all velocity values are taken into account.

Alternatively or additionally, in step 102 the mean acceleration v̅ of the sensing element 82 over a predetermined period of, for example, 10 s duration is calculated on the basis of previously received signals of the position sensor 88 (potentiometer 74). If the harvester 10 has not yet been continuously in operation over a period of such length, a predetermined value, or a value which can be inputted by the operator via a suitable input device (e.g. keyboard or rotary knob), may also be used. In one possible embodiment, only positive velocity values corresponding to an upward acceleration of the sensing element 82 are taken into account in calculating the mean acceleration. In other embodiments, the absolute values or squares of all acceleration values are taken into account.

In step 104, the current velocity v of the sensing element 82 is calculated. To this end, the difference resulting from the current position of the sensing element 82 and a previously measured position of the sensing element 82 is determined. This difference can be divided by the time elapsed between the measurements, so that a velocity value measured in m/s or some other chosen unit is obtained. Alternatively or additionally, in step 104, the current acceleration a of the sensing element 82 is calculated. To this end, the difference resulting from the current velocity of the sensing element 82 and a previously measured velocity of the sensing element 82 is determined. This difference can be divided by the time elapsed between the measurements, so that an acceleration value measured in m/s² or some other chosen unit is obtained.

In the following step 106, the calculated velocity v is compared with a threshold value determined by multiplying the mean velocity v̅ by a multiple r (e.g. r=2). In this case, as described above, only positive, upwardly directed velocities, or squares or absolute values of the velocity, can be taken into account. Alternatively or additionally, in step 106, the calculated acceleration a is compared with a threshold value determined by multiplying the mean acceleration ā by a multiple q (e.g. q=2). In this case, as described above, only positive, upwardly directed accelerations, or squares or absolute values of the acceleration, can be taken into account.

It would also be conceivable in step 106 to compare the velocities and/or accelerations with fixed threshold values which are fixedly programmed or can be inputted by the operator via a suitable input device (e.g. keyboard or rotary knob). This operating mode can also be selectable by the operator, as an alternative to the operating mode depicted in the previous paragraph.

If step 106 demonstrates that the velocity and/or acceleration is less than the threshold value, it may be assumed that no foreign body has been taken up with the swath 50, and step 102 follows again. Otherwise step 108 follows, in which the evaluation circuit 78 causes the apparatus 80 for stopping the gathering conveyor 42 to stop the latter, since a foreign body may possibly have been picked up. Moreover, the operator in the driver's cab 18 is notified of the response of the foreign body defector by means of a suitable display and/or an acoustic signal. The operator (or an appropriate automatic device) can then bring about a reversal of the gathering conveyor 42 and preferably of the crop receiver 20. Following removal of the foreign body, step 102 then follows again.

The evaluation circuit 78 and/or the apparatus 80 for stopping the gathering conveyor 42 can also be connected to a conventional metal detector (not shown), disposed in the pre-compacting roller 58, for the detection of ferromagnetic materials.

Furthermore, the evaluation circuit 78 feeds signals to an apparatus 86 connected to a GPS antenna 84, for mapping of the yield and/or dosing of a silage additive, which signals contain information on the position of the sensing element 82. They serve for the compilation of yield maps or for the dosing of a silage additive delivered into the crop stream.

Having described the preferred embodiment, it will become apparent that various modifications can be made without departing from the scope of the invention as defined in the accompanying claims.

1. A foreign body detector for an agricultural harvester, comprising a sensing element fitted such that it is movable transversely to a direction of conveyance of a crop and which, during the harvesting operation, bears against the received crop, wherein the foreign body detector comprises a position sensor set up to register the position of the sensing element, and an evaluation circuit, which can be operated to calculate on the basis of the signals of the position sensor information relating to at least one of the velocity or acceleration of the sensing element and, for the purpose of generating a signal value indicating the presence of a foreign body, to make a comparison with a threshold value.

2. A foreign body detector according to claim 1, wherein the sensing element is pre-tensioned in the direction of the crop.

3. A foreign body detector according to claim 1 wherein the sensing element is a driven conveying roller.

4. A foreign body detector according to claim 1 wherein the sensing element is a freely rotating conveying roller.

5. A foreign body detector according to claim 1 wherein the sensing element is assigned to a gathering conveyor of the harvester.

6. A foreign body detector according to claim 1 wherein the evaluation circuit is connected to a device for stopping a gathering conveyor of the harvester.

7. A foreign body detector according to claim 1 wherein the evaluation circuit is operated to derive the threshold value from previously registered measurement values of the position sensor so as to adapt it to the particular harvesting conditions.

8. A foreign body detector according to claim 1 wherein the position sensor comprises a potentiometer.

9. A foreign body detector according to claim 1 wherein the evaluation circuit is connected to a device for mapping of the yield and/or for dosing of a silage additive.

10. A harvester, having a foreign body detector comprising a sensing element fitted such that it is movable transversely to a direction of conveyance of a crop and which, during the harvesting operation, bears against the received crop, wherein the foreign body detector comprises a position sensor set up to register the position of the sensing element, and an evaluation circuit, which can be operated to calculate on the basis of the signals of the position sensor information relating to the velocity and/or acceleration of the sensing element and, for the purpose of generating a signal value indicating the presence of a foreign body, to make a comparison with a threshold value.
